(19) United States
(12) Patent Application Publication
(10) Pub. No.: US 2015/0356821 A1
(43) Pub. Date: Dec. 10, 2015

(54) SYSTEM AND METHOD OF PRIZE DISTRIBUTION IN AN ON-LINE GAME

(71) Applicant: Zuunda Inc., Washington, DC (US)

(72) Inventors: Mathias Entenmann, Munich (DE); Christian Bittler, Palma de Mallorca (ES); Roland Pickl, Vienna (AT)

(21) Appl. No.: 14/298,131

(22) Filed: Jun. 6, 2014

(51) Int. Cl. G07F 17/32

(52) U.S. Cl. CPC G07F 17/3244

(57) ABSTRACT

A method and system for distributing tickets in an online game includes downloading a potentially winning game ticket data element from a game administration module to a mobile device, the potentially winning game ticket element comprising a winning data element portion and a non-winning data element portion; detecting a completion of the playing of the game on the mobile device; and determining whether to award the winning data element portion of the potentially game winning ticket by: determining that the winning data element portion of the potentially winning ticket is winning eligible and detecting that the mobile device is online.

### FIELD

The aspects of the present disclosure relate generally to games of chance, and in particular to the distribution of prizes in an online game.

### BACKGROUND

In a game of chance, such as a sweepstakes, raffle or lottery, the prize or prizes are typically drawn at a certain time or during a certain time frame. Typically, such a contest will have a number of participants and a limited number of prizes to be awarded. However, in some cases, it is possible that all of the prizes to be awarded will not be given out. Since many of these contests have a marketing and publicity aspect to them, it can be desirable to want a majority of the prizes to be awarded. Thus, to ensure that all or a majority of the prizes are given out or awarded, multiple draws may be needed. This can be cumbersome to accomplish.

It is also possible that in some cases the winning tickets are given out and not redeemed. This can occur for a number of reasons, including, for example, losing the winning ticket or forgetting to redeem the ticket. From the contest organizer's point of view, giving out a winning ticket that goes unclaimed is not desired. However, if the winning ticket has been given out, and the reason that the ticket remains unclaimed is unknown, it could prove problematic to have another drawing to award the prize associated with that particular ticket. One problem that could arise is that after the prize is awarded in a subsequent drawing, the unclaimed winning ticket is presented for redemption. This presents a difficult situation where additional prizes may need to be awarded to maintain credibility.

One example is a scratch card game. A magazine gives out scratch cards along with the magazine. In this particular contest there are 10 top prizes and 10,000 medium prizes. Thus, there will be 10,010 winning scratch cards. The total number of scratch cards given out well exceeds the number of prizes. However, it is possible that not all 10 top prizes are won and that less than the total of 10,000 medium prizes are awarded. In some cases, it could be desirable to ensure that at least all of the 10 top prizes are awarded, as well as that a majority of the medium prizes are awarded. If new prize winning tickets were handed out, the organizers will want to avoid a situation where the same prize is awarded to more than one person. This could occur if and older winning card is attempted to be redeemed after the prize is awarded in a subsequent drawing for prizes that are initially unclaimed.

Another example is a raffle. In this example, 10,000 numbered tickets are given out or sold at the event and at a given time the ticket purchasers gather for the draw. The draw is being made for the top prize and a single ticket wins. However, the holder of the winning ticket may not be present or the prize otherwise goes unclaimed. One option in this case is to draw a second ticket and hope that the prize is claimed this time. If not, the process would be repeated until a winning ticket holder claims the prize. However, this creates additional work and can unnecessarily extend the time and resources needed for the event.

Electronic games can provide additional complexities. In these types of contests, electronic game tickets are typically downloaded to the electronic device, such as a mobile device. When the sweepstakes is played on electronic devices such as mobile phones with many participants it also has to be ensured that: a) the lucky winner can be informed and has “transaction security”, and, b) this communication can happen even with a large number of simultaneous users without the communication channel being a bottleneck. For the organizers and participants of a contest or game such as a sweepstakes, it will be more attractive and better for planning if it can be ensured that the top prizes are always given out in an efficient manner.

In a contest where one or more “winning” tickets or coupons are downloaded or awarded, whether an award or prize is awarded, meaning that the winning ticket is successfully redeemed, will depend in part on whether the holder of the winning ticket actually turns the ticket in for redemption. It is not unknown for a lottery prize to go unclaimed or un-awarded because the holder of the winning ticket does not present the ticket to claim the prize, or does not present the winning ticket for redemption within the allotted period of time. The causes for this can be many, including for example, the holder losing the ticket, not checking the ticket to see if it is a winner, or forgetting to claim the prize within an allotted time period. In such cases, the prize goes unclaimed.

Having a prize or award go unclaimed can be undesirable, particular in the case of certain types of product or marketing promotions where the aim is to increase consumer awareness of particular products and brands. In such cases, having an award or prize go unclaimed tends to defeat the purpose or reduce the effect of the particular promotion. It would be advantageous to be able to increase the probability that an award or prize will be redeemed in such contests.

Accordingly, it would be desirable to provide a prize distribution system for games played on electronic devices that addresses at least some of the problems identified above.

### BRIEF DESCRIPTION OF THE DISCLOSED EMBODIMENTS

As described herein, the exemplary embodiments overcome one or more of the above or other disadvantages known in the art.

One aspect of the exemplary embodiments relates to a method of distributing tickets in an online game of chance. In one embodiment, the method includes downloading a potentially winning game ticket data element from a game administration module to a mobile device, the potentially winning game ticket element comprising a winning data element portion and a non-winning data element portion; detecting a completion of the playing of the game on the mobile device; and determining whether to award the winning data element portion of the potentially game winning ticket by determining that the winning data element portion of the potentially winning ticket is winning eligible and detecting that the mobile device is online.

Another aspect of the disclosed embodiments is directed to a game ticket distribution system. In one embodiment, the system includes a game administration module; a mobile communication device; and a network coupling the game administration module and the mobile communication module, the game administration module including a processing device and a memory, the memory including non-transitory machine readable instructions stored thereon, the processing device, when executing the non-transitory machine readable instructions, being configured to cause the game administration module to: download a potentially winning ticket data element to the mobile device, the potentially winning ticket element comprising a winning data element portion and a non-winning data element portion; detect a completion of the playing of the game on the mobile device; and determine whether to award a prize associated with the winning data element portion of the potentially winning ticket by: detecting that the mobile device is online; and determining that the winning data element portion of the potentially winning ticket is winning eligible.

The aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

The accompanying drawings illustrate presently preferred embodiments of the present disclosure, and together with the general description given above and the detailed description given below, serve to explain the principles of the present disclosure. As shown throughout the drawings, like reference numerals designate like or corresponding parts.

FIG. 1 is a block diagram of an exemplary system incorporating aspects of the present disclosure.

FIG. 2 illustrates an exemplary data structure for a data element incorporating aspects of the present disclosure.

FIGS. 3A-3C illustrate a flowchart incorporating exemplary aspects of a process incorporating aspects of the present disclosure.

FIG. 4 illustrates screenshots of an exemplary game incorporating aspects of the present disclosure.

FIG. 5 shows a block diagram of an exemplary computing apparatus that can be used to practice aspects of the disclosed embodiments.

### DETAILED DESCRIPTION OF THE EXEMPLARY EMBODIMENTS OF THE DISCLOSURE

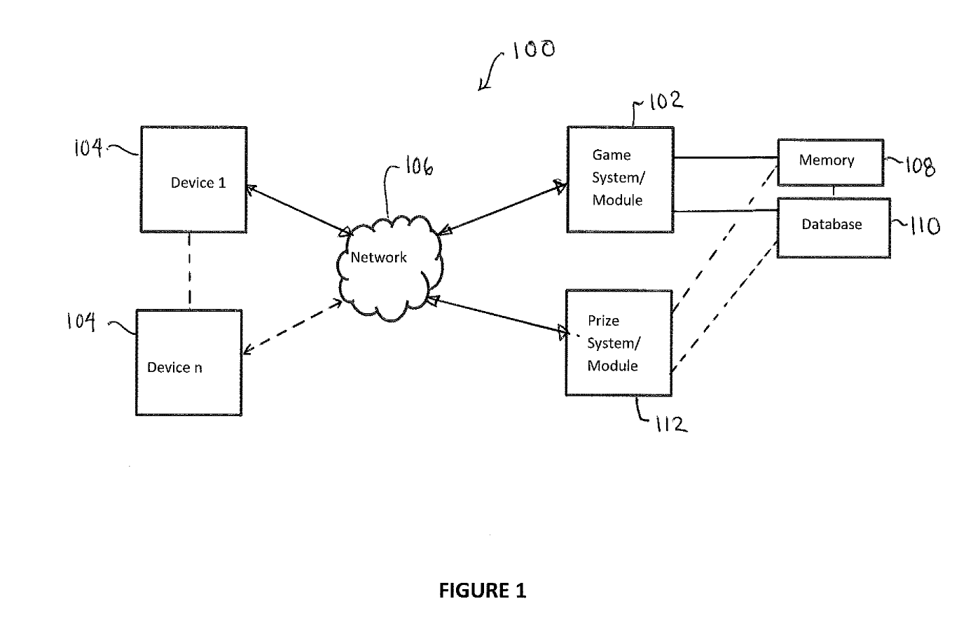

Referring to FIG. 1, one embodiment of a system 100 incorporating aspects of the disclosed embodiments is illustrated. The aspects of the disclosed embodiments are directed to automatically distributing and re-distributing the eligible winning tickets in an on-line electronic game or sweepstakes to ensure that most, if not all, of the eligible winning tickets are redeemed so the prizes might be awarded.

The system 100 will generally comprise a game administration system or module 102 that is communicatively coupled to one or more electronic or mobile communication devices 104. In one embodiment, the game administration system or module 102 generally comprises a computer or server that can be used to carry out aspects of the processes as are generally described herein. In one embodiment, the game administration system 102 is a general purpose computer system that includes or is coupled to a memory 108 and a data storage system 110, such as a database. Although the memory 108 and database 110 are shown as separate systems herein, in one embodiment they can comprise a single device, or a device that is part of the game administration module 102 or coupled thereto. The memory 108 and database 110 can also be part of or coupled to the prize administration module 112, when it is not part of the game administration module 102. Alternatively, the prize administration module 112 can include its own memory or database. Although only one game administration system 102 is shown in FIG. 1, in alternate embodiments, the game administration system 102 can be comprised of a network of distributed computerized devices. For example, the game administration system 102 can comprises a system of computerized systems, where each computerized system is configured to execute and carry out one or more aspects of the present disclosure. The aspects of the disclosed embodiments are generally configured to be implemented in hardware, software, application logic or a combination thereof.

The device 104 generally comprises any suitable device that is configured to communicate over and on an electronic or computer network, such as the Internet. Although only one device 104 is shown in FIG. 1, it will be understood that the aspects of the present disclosure can include one or more devices 104. Generally, in the context of a computerized or on-line game, the number of users can reach into the thousands or millions, with each user having at least one device 104.

In the example of FIG. 1, the device 104 includes any suitable electronic or mobile device, such as for example, computers, tablets, phablets, pads, terminals, kiosks, mobile phones, and mobile communication devices, such as smart phones. For the purpose of the disclosure herein, the device 104 will generally be referred to as a mobile communication device.

In the example of FIG. 1, the game administration system 102 and the device 104 are communicatively coupled together over a network 106. Examples of such a network can include, but are not limited to the Internet, a mobile communication network, or a Local Area Network (LAN). In alternate embodiments, the game administration system 102 and the device 104 can be communicatively coupled together in any suitable manner, or over any suitable network.

In one embodiment, the game administration system 102 and device 104 can be communicatively coupled together using a hardwire connection. In alternate embodiments, the game administration system 102 and device 104 can be communicatively coupled over a wireless connection. The aspects of the disclosed embodiments are not intended to be limited by the particular mode of coupling, connection and communication between the game administration system 102 and the device 104, and any suitable mode of communicative coupling and communication can be used.

In one embodiment, the game administration system 102 is configured to administer a game of chance. For the purposes of the disclosure herein, the games will generally be referred to as “contests.” Examples of such games of chance can include for example, but are not limited to, contests, lotteries, raffles, sweepstakes, scratch cards, or slot machines. For the purposes of the disclosure herein, the games or contests referred to will generally be in the realm of on-line games, where user participation, or the user execution of the game, is performed using a device 104. While the aspects of the present disclosure are described herein with respect to on-line contests and games, in one embodiment, the device 104 does not need to be on-line to execute or perform aspects the particular game functions. In one embodiment, aspects or functions of the game can be downloaded before the game is executed or performed, allowing the game to execute when the device 104 is off-line.

In one embodiment, a game or contest can include marketing promotions where a member of the consuming public is provided with an award or a coupon for participating in the promotion. Such promotions might include a sweepstakes or game of chance. While such a sweepstake might be administered on-line using a mobile communication device 104 or other suitable computing device, in one embodiment, such a sweepstakes could be administered using a terminal or kiosk in a store. Once the sweepstake has been completed, the user or customer can be presented with an opportunity to redeem a coupon for a prize. Examples of a prize might include a coupon or a product sample. While certain prizes or awards are referenced herein, the aspects of the disclosed embodiments are not intended to be limited by the particular type of award or prize. For example, prizes or awards could include a monetary award or an award of significant value, such as a car or a vacation. The aspects of the disclosed embodiments advantageously provide a system and mechanism to ensure that the potentially winning tickets or other suitable mechanism by which a prize is booked or redeemed, also referred to as awarded, does not go unused.

Still referring to FIG. 1, in one embodiment, the system 100 includes a prize administration system or module 112. The prize administration module 112 might also be referred to as a prize redemption module. Although the prize administration module 112 is shown as being a separate module from the game administration module 102, in one embodiment, the game administration module 102 and the prize administration module 112 comprises a single device, module or system. In the embodiment shown in FIG. 1, the prize administration module 112 and the game administration module 102 are configured to communicate with each other as well as the device 104, either directly or via a communication network, such as the network 106.

The prize administration module 112 is generally configured to administrate how the winning tickets are redeemed and/or redistributed, as is generally described herein. In one embodiment, the prize administration module 112 can also keep track of which prizes are booked and/or awarded. While the aspects of the disclosed embodiments are directed to the booking of an award, whether an award is actually collected or utilized, such as in the case of a coupon of monetary value, is not generally within the scope of contemplation of the present disclosure. However, the aspects of the disclosed embodiments will keep track of whether a prize is booked or awarded in order to ensure that the same prize is not booked twice. In one embodiment, this can include ensuring that there are still prizes left to be booked or awarded.

In the example of FIG. 1, the game administration module 102 may be responsible for administering the contest, including the distribution of the potentially winning tickets, or potentially winning tickets, as will be described herein. For example, after the user has played the game and identified as a winner, the user of the device 104 will then have the opportunity to get or claim the winning ticket. In one embodiment, this includes determining to award the winning portion of the potentially winning ticket as is described herein. For example, in one embodiment, the winning portion of the potentially winning ticket is awarded to the user, which the user can then use to get or claim the prize from the prize administration module.

In one embodiment, the database 110 shown in FIG. 1 can include a record of all tickets or coupons associated with the contest, as will be generally described herein. The record can include some type of marker or identifier for each ticket. In alternate embodiments, the tickets can be marked, identified and recorded in any suitable manner.

The aspects of the disclosed embodiments are directed to distributing tickets to mobile electronic devices as part of a contest or game. The user of the device can then play the game. If the results of playing the game identify or result in a winner, or a winning ticket, there is an opportunity for the winning ticket to be awarded and/or claimed. If the requirements for awarding and/or claiming the winning ticket are not satisfied, the winning ticket can be returned to the ticket pool. In one embodiment, the ticket is pre-determined to be a winning ticket, or have a winning portion. The playing of the game in that example is an exercise the can result in the winning ticket or winning portion being presented or otherwise awarded in a manner that provides the user with the opportunity to get the associated prize.

Potentially Winning Ticket

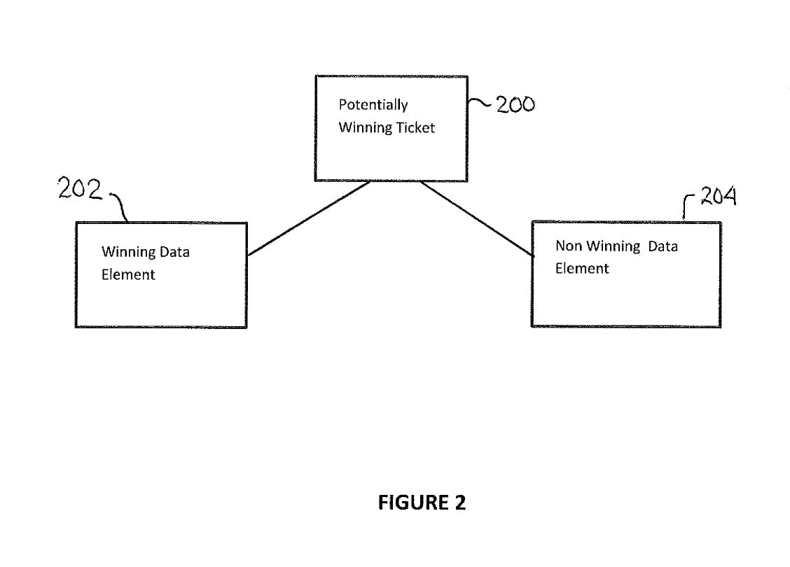

FIG. 2 illustrates one example of a potentially winning ticket or data element 200 incorporating aspects of the present disclosure. The potentially winning ticket 200 of the disclosed embodiments is a ticket or coupon associated with a game of chance or contest that has a prize associated therewith. In one embodiment, the prize can be awarded to the user once the game is played and other requirements satisfied, as will be generally described herein. In one embodiment, the potentially winning ticket or data element 200 comprises non-transitory computer readable code or machine readable instructions, that when executed by a processing device will carry out or enable the methods and processes generally described herein.

In the example of FIG. 2, the potentially winning ticket 200, also referred to as a data structure or data element, will comprise two data elements 202, 204. Although only two data elements are referred to herein, in alternate embodiments, the potentially winning ticket 200 can include more or less than two data elements. The first data element 202, also referred to as the winning data element or portion, is generally associated with a winning aspect of a game or contest, such as a prize to be awarded. For example, when the user plays the game and is deemed to be a winner, a prize can be awarded. In accordance with the aspects of the disclosed embodiments, the winner will have the opportunity to claim or book the prize associated with the winning data element after playing the game, by satisfying certain requirements as described herein. In one embodiment, this can include a determination to award the winning data element portion 202 to the user, who can in turn then claim the associated prize.

The second data element 204, also referred to as the non-winning or losing portion, is typically associated with a lower value prize (e.g. a 2^{nd}, 3^{rd}, or lower prize) or a consolation prize, or in some cases, no prize. In one embodiment, if the requirements associated with the winning data element 202 are not satisfied once the game has been played, the second data element 204 is exercised.

In one embodiment, the first data element 202 and second data element 204 comprise non-transitory computer readable code or machine readable instructions, that when executed by a processing device will carry out or enable the process generally described herein. For example, in one embodiment, the first data element 202 and second data element 204 will include comprise non-transitory computer readable code or machine readable instructions that when executed by one or more of the device 104 or the module 102, will carry out or enable the process generally described herein.

Although the aspects of the disclosed embodiments refer to a “ticket” or a “winning ticket”, it will be understood that the potentially winning ticket 200 can comprise any suitable representation of an aspect of the contest or game of chance referred to herein. For example, when the contest is a scratch card game, the winning ticket 200 will be digital representation of the scratch card. When the contest is a slot machine, the winning ticket 200 will be a digital representation of the slot machine and a certain result combination of the symbols on the dials of the slot machine. When the game associated with the potentially winning ticket 200 is played, such as by scratching the scratch card elements or playing the slot machine, the results of the play will be a win (or winner) or a 2^{nd} or lower or a losing combination. The winning data element portion 202 and the non-winning data element portion 204 will be relevant to the type or category of award or prize associated with winning the game or contest.

In one embodiment, the winning data element portion 202 is associated with a first prize or award. The non-winning data element portion 204 can be associated with a second prize or award. For the purposes of the description herein, a value of the first prize can be understood to have a value greater than the value of the second prize, also referred to as a consolation prize. However, the aspects of the disclosed embodiments are not intended to be limited by the particular types of prizes, and any suitable prizes or prize combinations are contemplated.

Distribution

In one embodiment, at the start of a contest or game, it is determined how many contestants there will be, or anticipated to be. It will also be known or determined how many prizes are to be given away. For example, in one embodiment, the game may have 100,000 tickets in total, with ten prizes to be given away.

To ensure that there is ample opportunity for each of the ten prizes to be given away, typically more potentially winning tickets 200 will be distributed than there are prizes. For example, for the ten prizes, there can be 1,000 potentially winning tickets distributed out of the total of 100,000 tickets. It is noted, that the numbers here are merely exemplary, and in alternate embodiments, any suitable numbers and ratios can be provided. In accordance with the aspects of the disclosed embodiments, in this example, the first ten potentially winning tickets 200 of the 1000 potentially winning tickets 200 that satisfy the requirements generally described herein, will enable the user to book or redeem the winning prize associated therewith. The remaining potentially winning tickets 200 will no longer be eligible or enabled to, redeem a prize.

As another example, the potentially winning tickets 200 for a contest are distributed at randomly numbered positions within “batches” of the expected total number of tickets divided by the number of top prizes. For example, a sweepstakes using scratch cards has 10,000 expected participants with 10,000 expected scratch cards to be given out. In one embodiment, the initial distribution of tickets randomly assigns an identifier or number for the 10 winning cards in 10 batches of 1,000 tickets. So the first potentially winning ticket 200 will be randomly assigned a number between 1 and 1,000, the second potentially winning ticket 200 between 1,001 and 2,000, the third potentially winning ticket 200 a number between 2,001 and 3,000, and so on for all of the potentially winning tickets 200. All of the tickets or scratch cards are stored as a data structure or data element on the game administration system 102. The participants will call and/or collect their tickets via their devices 104, which in this example comprise mobile phones. In one embodiment, the tickets, including the potentially winning tickets 200 can be drawn one after the other by the mobile devices 104 from the game administration system 102.

The mode of downloading or distributing tickets, including potentially winning tickets, will generally depend upon the particular game or contest. The aspects of the disclosed embodiments are not intended to be limited by the particular mode of download or distribution of tickets. Rather, the aspects of the disclosed embodiments are directed to the processing of a potentially winning ticket 200 to ensure that the prizes associated with the winning data element 202 do not go un-booked.

Validity Period

In one embodiment, the winning data element portion 202 of a potentially winning ticket 200 will be associated with a validity period. The validity period generally refers to a period of time within which the requirements associated with the winning data element portion 202 of the potentially winning ticket 200 must be satisfied. If the requirements are not satisfied within this validity period, the potentially winning ticket 200 reverts to the non-winning data element portion 204 or is otherwise deemed not eligible to be redeemed for the prize otherwise associated with the winning data element portion 202. In one embodiment, reverting to, or executing the non-winning data element portion 204 generally means that the instruction(s) associated with the non-winning data element portion 204 are executed or carried out.

In one embodiment, a validity time period will run from a point in time when the potentially winning ticket 200 was downloaded to the device 104 or the game was played, for example. The point of time and validity period can be a time of day, a clock time or the device time, for example. In alternate embodiments, any suitable time or time period can be used as the validity time period.

Generally, the time limit of the validity time period will be significantly smaller than the overall time for the contest or sweepstakes. In an example of a sweepstake of 10,000 scratch cards, the time for the entire game could be 10 hours. The validity time period for a winning ticket data element 202 can be a fraction of that, say 60 minutes. After this time limit has expired, the winning ticket data element 202 is no longer valid and when the participant plays opens or otherwise activates the potentially winning ticket 200, he will always see the non-winning ticket data element portion 204, also referred to as the 2^{nd} prize or lower prize, or consolation prize or losing ticket.

The validity time period of the winning data element portion 202 of the potentially winning ticket 200 can be maintained and determined in any suitable fashion. As one example, the validity time period can be kept by the device 104. The device 104 can detect when the download of the potentially winning ticket 200 occurs, and start or otherwise activate a timer or clock function of the device 104. In one embodiment, the validity time period is maintained by the potentially winning ticket 200 or the game administration module 102.

In one embodiment, a timer can be used to keep track of the validity time period. The timer can be a physical device in either the device 104 or game administration system 102, or a function that is associated with the potentially winning ticket 200. The timer can also include a timestamp associated with the winning data element portion 202 of the potentially winning ticket 200 that can later be compared to a current time. In one embodiment, the potentially winning ticket 200 can comprise non-transitory computer readable instructions that are configured to be executed by a processor of the device 104 to maintain and determine the validity time period. In one embodiment, this can include updating the database 110 to reflect this download time.

In one embodiment, during the course of a contest, after an initial distribution of tickets from the game administration system 102, it might be expected that the number of expected participants and the time limit or validity of the potentially winning tickets 200 will be adjusted. For example, there is an initial expectation of 10,000 participants in the scratch card game referred to above, there are 10 prizes to be awarded and the initial validity time limit or period is 60 minutes. In one embodiment, an operator of the contest such as the game system 100, for example, or such other suitable administrator, can be configured to check after a certain time period, such as one hour, and determine whether more or less participants than initially expected are participating in the contest. If needed, the distribution and/or time validity of the potentially winning tickets can be adjusted.

For example, the number of participants might grow to 15,000 expected participants based on initial responses or interest, or the sweepstake runs slower and the expectation might be down-graded to only 7,500 participants. This would mean that the number of potentially winning tickets 200 should be more equally distributed within a larger or smaller number of total tickets. The aspects of the disclosed embodiment seek to ensure that there is a high probability that all winning prizes will be given out, he prizes are fairly equally distributed and contestants participating or downloading their tickets relatively late in the game process still have a chance of receiving a potentially winning ticket 200.

Requirements

In one embodiment, the requirements to be satisfied with respect to determining whether to award the winning data element portion 202 of a potentially winning ticket 200 can include: (1) the winning data element portion 202 being presented or redeemed within the validity period; and (2) the device 104 being on-line or otherwise communicatively coupled to the game administration system 102. The term “redeemed” as is used herein is generally intended to mean that the winning data element portion 202 of the potentially winning ticket 200 is exercised in order for the prize associated therewith to be booked, for example in or with the prize system module 112. In one embodiment, exercising a data element herein generally means executing the instructions stored on or associated with the data element to carry out one or more processes.

Once the game is initiated and the winning data element portion 202 of the potentially winning ticket identified, a check will be made to determine that the winning data element portion 202 is being exercised within the validity period. Generally, the validity of the winning data element portion 202 of the potentially winning ticket will be determined prior to the user starting the game. For example, when a selection or other action is taken to initiate and/or play the game, the validity check can be carried out. In one embodiment, this can include comparing different time stamps, or checking a timer, clock or countdown function. If the validity time period has expired, the non-winning data element portion 204 of the potentially winning ticket 200 is exercised.

In one embodiment, the aspects of the present disclosure provide two checks to determine if the device 104 is on-line. A first check is made at the initiation or start of the game and a second check when the winning data element portion 202 is executed, or the prize from playing the game is shown. The term “on-line” as used herein, generally indicates that the device 104 is connected with or communicating to and over the network 106 to one or more of the game administration module 102 or the prize administration module 112. If both online checks are positive, meaning that the device 104 is online, the winning data element portion 202 is executed and the prize can be booked or awarded. If both of the online checks are negative, the non-winning data element portion 204 is executed.

If the first online check fails, the non-winning data element portion 204 of the potentially winning ticket 200 is exercised. This can include presenting a digital representation of the non-winning data element portion 204 of the potentially winning ticket 200 on the device 104.

If the first online check is successful, but the device 104 is offline after the game is successfully played, a limited amount of time can be provided within which the device 104 can be brought on line and the winning data element portion 202 of the potentially winning ticket 200 exercised. In one embodiment, this time period can be or include, any remainder of the validity time period. If one or more of this time period or the validity time period expires, the non-winning data element portion 204 of the potentially winning ticket 200 is exercised.

The aspects of the disclosed embodiments allow for the participant to be informed that the participant is close to winning the prize, but will only win if it is determined that the device 104 gets connectivity within the remaining validity time period. As an example the participant can be provided with a message that reads: “you are close to winning a prize if your phone is connected to the internet in the next 53 minutes and 29 seconds.” Once this period expires, the winning data element portion 202 is no longer valid or winning eligible and non-winning data element portion 204 of the potentially winning ticket 200 is exercised.

In another embodiment, one requirement for exercising the winning data element portion 202 of a potentially winning ticket 200 can include determining that there is a prize to be awarded. For example, there will typically be more potentially winning tickets 200 distributed than there are prizes to be given out. In this example, when the winning data element portion 200 is exercised, this could include a check of one or more of the game administration module 102 or the prize administration module 112 to determine if there are still prizes to be given out. If not, the non-winning data element portion 204 of the potentially winning ticket 200 is exercised. In one embodiment, the check to determine if there are still prizes to be awarded can be performed when the game is first initiated and the on-line check is made. In this way, if there are no more prizes remaining, the non-winning data element portion 204 can be immediately exercised.

Return to Pool of Tickets

In one embodiment, if the requirements associated with a winning data element portion 202 of a potentially winning ticket 200 are not satisfied, the winning data element portion 202 can be returned to the pool of tickets for redistribution or otherwise identified as still eligible for winning.

For example, if the validity time period has expired, or the device 104 is not on-line or cannot connect, the non-winning data element 204 is exercised. In this example, the prize associated with the non-winning data element 204, if such a prize is available, is presented on the device 104 to the participant. When the non-winning data element 204 is presented, this can be reported back to the game administration system 102 when the device 104 has connectivity. The database 110 can be updated to reflect that the winning data element portion 202 of this particular potentially winning ticket 200 is still, or again, winning eligible. The winning data element portion 202 can then be returned to the ticket distribution pool. In one embodiment, this includes associating the winning data element portion 202 with another potentially winning ticket 200.

While the present disclosure generally describes a winning data element portion 202 being returned to the ticket distribution pool, in one embodiment, this can include marking another winning data element portion 202 of another potentially winning ticket 200 with the identifying information as the one that is marked as winning eligible. This allows only the database 110 and data record to be updated and maintained and can include the changing or adjustment of the validity periods of one, several or all potentially winning tickets 200 in a contest or game. Although the change or adjustment is described as occurring in the database 110, in one embodiment, the change or adjustment can occur or be reflected in the potentially winning ticket 200 downloaded in the device 104, or in both the database 110 and the potentially winning ticket 200 on the device 104.

In one embodiment, the winning data element portions 202 of potentially winning tickets, will be marked or otherwise recorded in the database as:
i) claimed;
ii) downloaded to a device 104, still within the time limit or validity time period but not claimed yet;
iii) having previously being numbered and recorded in the database 110, (whether with or without being downloaded), but the time limit being expired or the potentially winning ticket 200 was played with a non-winning ticket data element 204 being the result of any claim, which in both of these cases results in the winning prize associated with the winning data element portion 202 for this particular potentially winning ticket 200 being free to be distributed, given out or awarded; or
iv) recorded in the ticket data record 110 with an identification number, but has not been downloaded to a device 104 yet.

In one embodiment, in regular intervals and/or after the expiry of the validity period time limit, the system 100 will prompt for the distribution of all potentially winning tickets 200 that are still available, or for which the prizes are still available, either automatically or with operator support. This can include new potentially winning tickets 200 that have not been distributed or potentially winning ticket 200 that have been returned as unclaimed and marked for redistribution.

Exemplary Process Flow

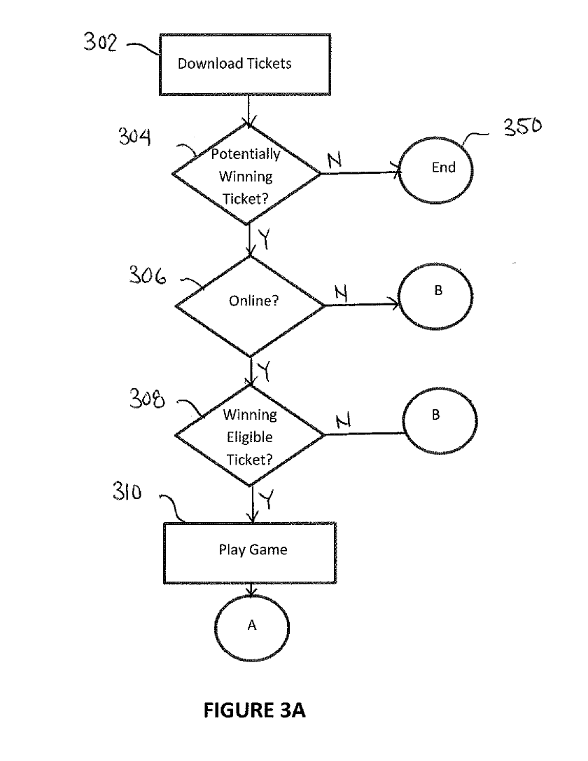

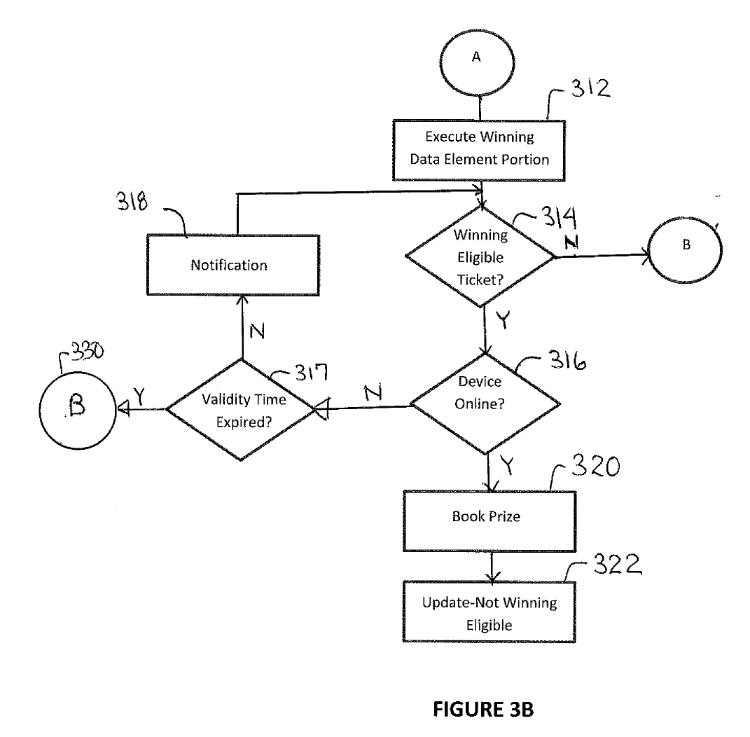

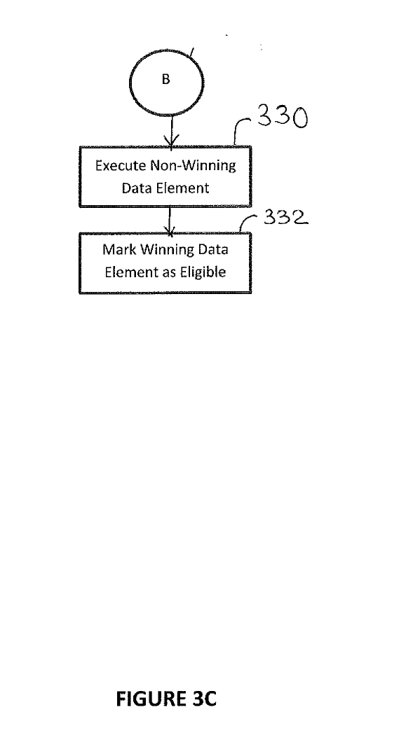

FIGS. 3A and 3B illustrates one example of a process 300 incorporating aspects of the disclosed embodiments. In this example, referring to FIG. 3A, the tickets associated with a game or contest are downloaded 302 to the respective devices 104. This includes downloading the potentially winning tickets 200 to one or more of the devices 104. In one embodiment, this can include downloading two separate data elements 202, 204, or a single data element comprising two portions 202, 204.

It is determined 304 whether a potentially winning ticket 200 is downloaded to the device 104. If the downloaded ticket is not a potentially winning ticket, the process ends 350. In one embodiment, whether the downloaded ticket is a potentially winning ticket 200 can be known or otherwise identified to the device 104 when or at the time the potentially winning ticket 200 is downloaded 302 to the device 104.

If the downloaded ticket is a potentially winning ticket 200, in one embodiment, a check 306 is made to determine if the device 104 is online. If the device 104 is not on-line, the non-winning portion 204 of the potentially winning ticket 200 is executed 330. If the device 104 is on-line, in one embodiment, it is determined 308 whether or not the winning data element portion 202 is winning eligible. In one embodiment, this can include determining one or more of whether the validity period associated with the winning data element portion 202 has expired and whether there is a prize available to be awarded. The winning data element portion 202 is winning eligible if the validity time period has not expired and there are still prizes left to be awarded.

If the validity time period has expired, the winning data element portion 202 is not winning eligible and the non-winning data element portion 204 of the potentially winning ticket 200 can be executed 330. If there are no prizes left to be awarded, here again, the winning data element portion 202 is not winning eligible and the non-winning data element portion 204 of the potentially winning ticket 200 can be executed 330.

If the winning data element portion 202 is winning eligible, the game is played 310. Although the example of FIG. 3A shows that the checks 306 and 308 occur before the game is played 310, in one embodiment, one or more of the checks 306, 308 can occurs after the game is played 301, at or during the start of the game play 310, or during the game play 310.

In one embodiment, when the ticket is downloaded 302 to the device 104, the contest or game associated with the ticket is presented on the device 104. As an example, in the case of a scratch card game, a digital representation of the scratch card can be presented on the device 104 for the user to play. Generally, playing 310 the game comprises the device 104 executing one or more instructions to carry out the particular game functions or requirements. These can include for example, but are not limited to “scratching” elements of a scratch card, matching icons in a slot machine, rolling a dice, or rolling a ball in a roulette wheel, it being understood that these effects are digital representations that are executed on the device 104. The aspects of the disclosed embodiments are not intended to be limited by the particular type of game or contest.

In one embodiment, referring to FIG. 3B, after the game is played 310, the winning data element portion 202 of the potentially winning ticket 200 is executed 312. In one embodiment, if it has not already been determined, this includes determining 314 whether or not the winning data element portion 202 is winning eligible. In this example, this could include determining one or more of whether the validity time period of the winning data element portion 202 of the potentially winning ticket 200 has expired or a prize is still available to be awarded. In one embodiment, this can be a second check, depending upon how long it took to complete the game play 310. If the validity time period has expired, the non-winning data element portion 204 of the potentially winning ticket is executed 330, referring to FIG. 3C. Although this example illustrates determining the validity time period when the winning data element portion 202 of the potentially winning ticket 200 is executed 312, in one embodiment, the validity time period can be determined before the winning data element portion 202 of the potentially winning ticket 200 is executed 312.

If the validity time period has not expired and a prize is still available, in one embodiment, it is determined 316 whether the device 104 is online. If the device 104 is not online, it is determined 317 if there is still time remaining in the validity time period or whether the validity time period has expired. If the validity time period has not expired, in one embodiment, a notification 318 can be provided informing the user that there is a limited amount of time within which to go online and claim the prize.

If the validity time period has not expired and the device 104 is online, in one embodiment, the award or prize can be booked 320. In one embodiment, this can include identifying or otherwise recording that the winning data element portion 202 of the potentially eligible ticket 200 is no longer winning eligible. For example, in one embodiment, one or more of the ticket database 110 or the prize system module 112 can be updated 322 with this information.

Referring to FIG. 3C, if it is determined 308 that the potentially winning ticket 200 is not winning eligible, or it is determined 314 that the validity time period is expired, or that the non-winning data element portion 204 is executed 330. In one embodiment, executing 330 the non-winning data element 204 can include marking or otherwise identifying 332 the winning data element portion 202 of the respective potentially winning ticket 200 as not or no longer winning eligible. This can include updating one or more of the database 110 and the prize system module 112. This allows the winning data element portion 202 to be redistributed with another potentially winning ticket 200, if needed or desired.

The aspects of the disclosed embodiments advantageously ensure that the more significant prizes are likely to be awarded by redistributing potentially winning tickets 200, or the winning data element portions 202 of potentially winning tickets 200. In one embodiment, this can include associating a winning data element portion 202 that is deemed to be ineligible, with another potentially winning ticket 200. The aspects of the disclosed embodiments enable the winning data element portions 202 of potentially winning tickets 200 to be reintroduced into the ticket pool or be assigned to tickets which have not yet been downloaded for distribution. This increases the likelihood that the prizes will be claimed or awarded. One benefit of this embodiment is that this reduces the communication needs and network traffic during a game or contest because only a limited number of potentially winning tickets 200 will communicate with the central system 100.

When only the non-winning data element portion 204 can be exercised, such as when certain conditions associated with the winning data element portion are not met or satisfied, the aspects of the disclosed embodiments will still enable those participants to receive some type of prize.

In one embodiment, the winning data element portion 202 of a potentially winning ticket will be marked with an identifier or otherwise recorded in the database 110. For example, the database 110 can include or comprise a data record of each winning data element portion 202 of each potentially winning ticket 200. This allows the state of each winning data element portion 202 to be known and status identified. In one embodiment, the status can be winning eligible or non-winning eligible.

For a winning data element portion 202 that is executed and the associated prize awarded, the corresponding data record for that winning data element portion 202 can be marked as not winning eligible or prize awarded. When a winning data element portion 202 is executed and the associated prize cannot be awarded, such as when all of the requirements cannot be met, the corresponding data record can be marked as winning eligible. This allows that particular winning data element portion 202 to be redistributed into the game pool of tickets with another potentially winning ticket 200. The next participant to whom this particular potentially winning ticket is downloaded will have an opportunity to “win” the associated prize, in accordance with the embodiments disclosed herein.

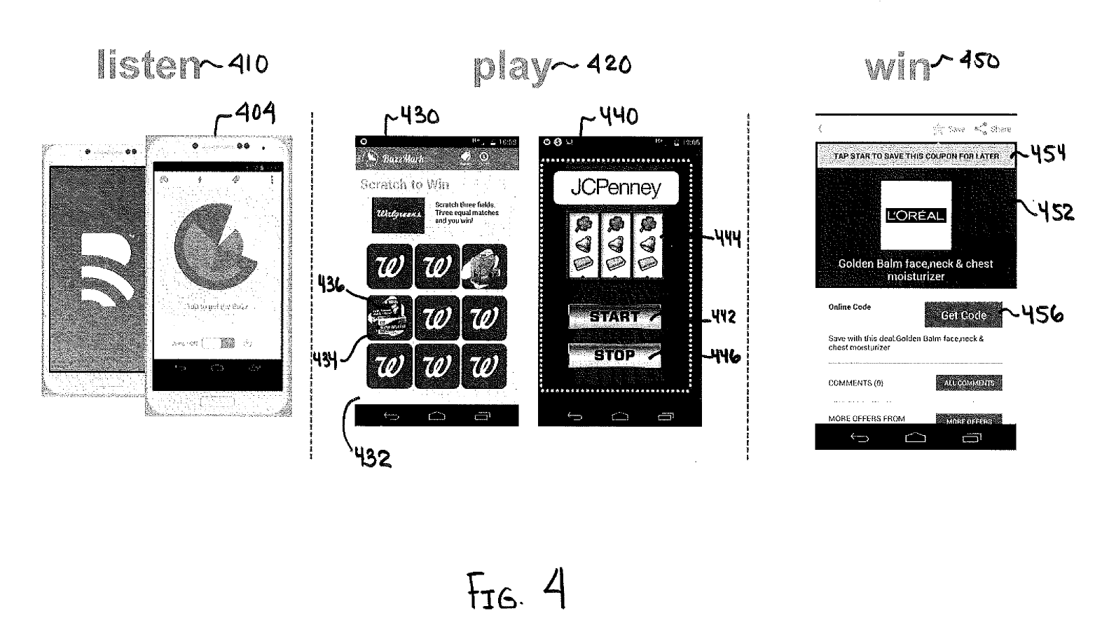

FIG. 4 illustrates an exemplary process incorporating aspects of the present disclosure. In this example, the device 104 from FIG. 1 is a mobile device 404 such as a smart phone and is used to detect an advertisement. As shown by the “listen” screen shots 410, in this example, the mobile device 404 uses an audio detection application to listen to an advertisement or audio stream and identify the advertiser. In one embodiment, the browser or other Internet application of the mobile device 404 can be directed to the website or portal for the particular advertiser. In one embodiment, this can include establishing a communication connection with the game administration system 102 of FIG. 1. In this example, the browser of the mobile device 404, after listening to the audio stream, is automatically re-directed to a gaming application that is associated with the advertiser. The play screenshot 420 illustrates screenshots for two such games 430, 440 or gaming examples, screenshot 430 being for a scratch card type of game, screenshot 440 being a slot machine type of game.

In screenshot 430 an electronic scratch card 432 is presented. As will be generally understood, certain fields 434 on the scratch card 432 are “scratched” or otherwise altered to reveal a potential prize underneath. In this example the fields 434 are in the form of squares. In alternate embodiments, the fields 434 can be any geometric shape, such as circles and triangles. In this particular example, if three fields 434 are “scratched” and reveal the same or matching “prize”, this represents a winning combination or play.

In screenshot 440, a slot machine game is presented. As will be generally understood, when the start bar 442 is selected, the icons in areas generally indicated as 444 will be move or otherwise be randomly distributed. After a certain period of time, or when the stop bar 446 is selected, if the icons in each of the areas 444 match, a prize is won.

The win screenshot 450 illustrates on example of how a prize might be presented or can be awarded after playing an electronic or online game, such as that shown in screen shots 430, 440, in accordance with the aspects of the present disclosure. In this example, the prize is in the form of an electronic coupon 452. As shown in the screenshot 450, in this example, the user can tap or activate the area 454 to save the coupon for later use, or can activate the field or area 456 on the device 404 to get a code to redeem the electronic coupon. The aspects of the disclosed embodiments can be utilized in the above example to ensure that the coupon, which is the result of or represents a winning data element portion 202, is redeemed within a certain period of time, as is generally described herein.

In the example of FIG. 4, after the game is played, the eligibility for a prize is presented to the user in the form of the coupon 452, corresponding to the winning data element portion 202. In one embodiment, the user can be prompted to activate or execute the winning data element portion 202, such as by activating the field 454 or 456 of the mobile device 404. As will be generally understood, activating the field 454, 456 can be a “click” or other suitable interaction with the respective field 454, 456.

As another example, in one embodiment, all or most of the contestants or participants in the game will be known to the game administration module 102. In this example, the tickets, including the potentially winning tickets 200, can be downloaded to the devices 104 substantially all at once. Alternatively, the tickets can be downloaded in blocks or batches. The game or contest can then begin either with all tickets having been downloaded before the start or downloads still continuing until the game or contest ends.

One example of a game or contest can include a game with a limited playing period, such as 2 hours or 120 minutes and 120 top prizes to be given away In this particular example, there will be 120,000 tickets with 1200 potentially winning tickets 200. In an exemplary distribution, these 1200 potentially winning tickets 200 could be evenly distributed over the 120 minutes of playing time with 10 potentially winning tickets distributed or assigned over each minute of the 120 minutes of playing time. The potentially winning tickets 200 in this example, will then be executed as is described herein, such as for example, with respect to FIGS. 3A-3C.

In one embodiment, the tickets can be downloaded during a certain time period, say 6:00 pm and 10:00 pm. A drawing can occur between 10:30 pm and 11:00 pm. A distribution algorithm can be used to ensure that the potentially winning tickets 200 are evenly and randomly distributed.

In this example, a certain number of potentially winning tickets 200 will be valid for a predetermined period of time within the time period allotted for the drawing. For example, a first batch can be valid from 10:30 to 10:31, a second batch from 10:31 to 10:32 and so on. The number of potentially winning tickets 200 in each batch can be substantially the same. Thus, in this example, the validity period of a batch of potentially winning tickets is time based.

In an alternate embodiment, a potentially winning ticket 200 will not have a validity time period associated therewith. Rather, in this example, the potentially winning tickets 200 are given out and exercised to be awarded on a first come, first serve basis. In this example, a check can be made to determine if there are any prizes left to be awarded. If not, only the non-winning portion 204 of the potentially winning ticket 200 can be exercised or executed. In one embodiment, if it is determined that all possible prizes have been awarded, all remaining potentially winning tickets 200 will automatically expire or otherwise be marked as not eligible.

In this example, a potentially winning ticket 200 is downloaded and the game played. Since this is a potentially winning ticket 200, after the game is played, the winning data element portion 202 of the potentially winning ticket 200 will execute. If the device 104 is online, a check can be made to determine if there are any more prizes available to be awarded. In one embodiment, the check is performed prior to the game being played. If there are no more prizes to be awarded, the non-winning portion 204 of the potentially winning ticket 200 is executed or otherwise presented to the participant.

If the device 104 is online and the check determines that there are prize to be awarded, the prize can be booked against the particular winning data element portion 202 of the potentially winning ticket 200. The process can continue until all prizes have been booked or awarded.

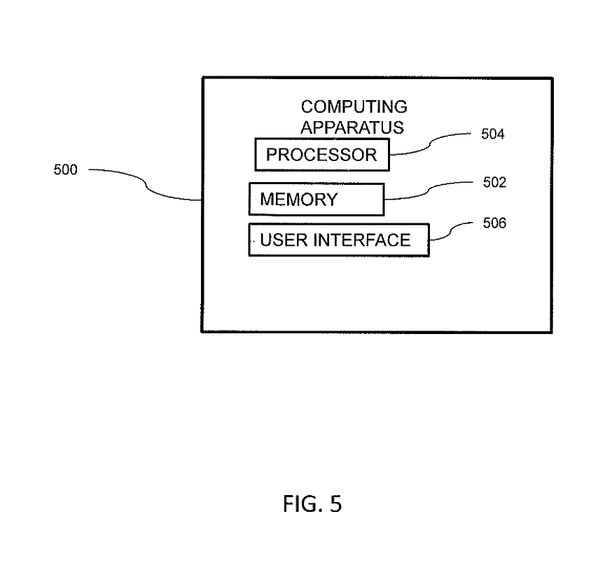

In at least one aspect of the disclosed embodiments, the systems and methods disclosed herein may be executed by one or more computers under the control of one or more programs stored on a computer readable medium. FIG. 5 shows a block diagram of a computing apparatus 500 that may be used to practice aspects of the disclosed embodiments. In at least one exemplary aspect, each of the game system 102, user device 104, prize system module 112 and other disclosed devices and systems may be implemented using an instance or replica of the computing apparatus 500 or may be combined or distributed among any number of instances or replicas of computing apparatus 500.

The computing apparatus 500 may include computer readable program code stored on at least one computer readable medium 502 for carrying out and executing the processes and methods described herein. The computer readable medium 502 may be a memory of the computing apparatus 500. In alternate aspects, the computer readable program code may be stored in a memory external to, or remote from, the apparatus 500. The memory may include magnetic media, semiconductor media, optical media, or any media which is readable and executable by a computer. Computing apparatus 500 may also include a processor 504 for executing the computer readable program code stored on the at least one computer readable medium 502. In at least one aspect, computing apparatus may include one or more input or output devices, generally referred to as a user interface 506, similar to the user interface described above, which may operate to allow input to the computing apparatus 500 or to provide output from the computing apparatus 500, respectively. The user interface may include one or more of a display, touch screen, buttons, audio input device and audio output device. Communications between the different modules can be in any suitable communication format or subscribe to a suitable communication protocol. In one or more of the embodiments, one or more the communications and data elements can be in an encrypted format.

The aspects of the disclosed embodiments provide a system and method for distributing prize tickets in an online game. The potentially winning tickets that are distributed will have two components, a winning data element component and a consolation or non-winning data element component. The exercise or execution of the winning data element component provides for an award to be booked. However, if the requirements associated with the winning data element component are not met within a certain period of time, the non-winning data element component of the potentially winning ticket will be exercised. The winning data element portion of this ticket is then marked as winning eligible, so that it can be associated with another ticket for redistribution into the ticket pool. In this manner, the winning data element components of potentially winning tickets that are still eligible for winning can be effectively redistributed to maximize the potential for award distribution and redemption.

Thus, while there have been shown, described and pointed out, fundamental novel features of the invention as applied to the exemplary embodiments thereof, it will be understood that various omissions and substitutions and changes in the form and details of devices and methods illustrated, and in their operation, may be made by those skilled in the art without departing from the spirit of the invention. Moreover, it is expressly intended that all combinations of those elements and/or method steps, which perform substantially the same function in substantially the same way to achieve the same results, are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for distributing tickets in an online game, comprising:
downloading a potentially winning ticket data element from a game administration module to a mobile device, the potentially winning ticket element comprising a winning data element portion and a non-winning data element portion;
detecting a completion of the playing of the game on the mobile device; and
determining whether to award a prize associated with the winning data element portion of the potentially winning ticket by:
determining that the winning data element portion of the potentially winning ticket is winning eligible; and
detecting that the mobile device is online.

2. The method according to claim 1, wherein determining that the winning data element portion of the potentially winning ticket is winning eligible comprises:
determining that a validity period associated with the winning data element portion of the downloaded game ticket data element has not expired.

3. The method according to claim 2, wherein determining whether the validity period associated with the winning data element portion of the downloaded potentially winning game ticket data element has not expired occurs at an initiation state of the game.

4. The method according to claim 2, wherein the validity period comprises a fixed time period after the download of the potentially winning game ticket data element to the mobile device.

5. The method according to claim 2, wherein the validity period comprises a pre-determined time period.

6. The method according to claim 2, comprising, when it is determined that the validity period associated with the winning data element portion is expired:
executing an instruction associated with the non-winning data element portion of the potentially winning game ticket data element.

7. The method of claim 6, comprising:
marking the winning data element portion of the potentially winning game ticket data element as winning eligible.

8. The method according to claim 1, wherein determining that the winning data element portion of the potentially winning game ticket data element is winning eligible comprises determining that a prize associated with the winning data element portion of the potentially winning game ticket data element is available.

9. The method of claim 1, wherein detecting that the mobile device is online comprises detecting that the mobile device is online upon an initiation of the game and detecting that the mobile device is online upon a completion of the game.

10. The method of claim 1, comprising, when it is determined that the mobile device is not online:
executing at least one instruction of the non-winning data element;
marking the winning data element as expired or not claimed; and
identifying the prize associated with the winning data element as eligible for another potentially winning data element on another mobile device.

11. The method of claim 1, wherein determining whether to award the prize associated with the winning data element portion of the potentially game winning ticket, further comprises:
determining that the device is online prior to playing the game;
determining that the device is online after the completion of the game;
determining that a validity period associated with the winning data element portion has not expired; and
booking the award against the winning data element portion.

12. The method of claim 1, wherein determining whether to award the prize associated with the winning data element portion of the potentially game winning ticket comprises:
determining if a prize associated with the winning data element portion of the potentially game winning ticket is available; and
if the mobile device is online, awarding the prize.

13. The method according to claim 12, comprising, after the prize is awarded, identifying a winning data element portion of another potentially winning ticket data element on another mobile device as not winning eligible.

14. A computer program product comprising non-transitory computer readable code means, which when executed by a processing device, are configured to implement the method according to claim 1.

15. A game ticket distribution system, comprising:
a game administration module;
a mobile communication device; and
a network coupling the game administration module and the mobile communication module, the game administration module including a processing device and a memory, the memory including non-transitory machine readable instructions stored thereon, the processing device, when executing the non-transitory machine readable instructions, being configured to cause the game administration module to:
download a potentially winning ticket data element to the mobile device, the potentially winning ticket element comprising a winning data element portion and a non-winning data element portion;
detect a completion of the playing of the game on the mobile device; and
determine whether to award a prize associated with the winning data element portion of the potentially game winning ticket by:
detecting that the mobile device is online; and
determining that the winning data element portion of the potentially winning ticket is winning eligible.

16. The system according to claim 15, wherein the processing device, when executing the non-transitory machine readable instructions, is configured to cause the game administration module to determine if the winning data element portion is valid by:
determining in the mobile device whether a validity period associated with the winning data element portion of the downloaded game ticket data element has expired; and
if the validity period associated with the winning portion has not expired and the device is online, booking a prize with the winning data element portion of the downloaded game ticket data element.

17. The system according to claim 12, wherein the processing device, when executing the non-transitory machine readable instructions, is configured to cause the game administration module to determine whether the validity period associated with the winning data element portion of the downloaded potentially winning game ticket data element has not expired occurs at an initiation state of the game.

18. The system according to claim 12, wherein the processing device, when executing the non-transitory machine readable instructions, is configured to cause the game administration module to determine upon an initiation of the game whether the winning data element portion of the downloaded ticket data element is winning eligible.

19. The system according to claim 18, wherein the processing device, when executing the non-transitory machine readable instructions, is configured to cause the game administration module to:
determine that the validity portion associated with the winning data element portion of the potentially winning ticket is expired;
execute an instruction associated with the non-winning data element portion of the potentially winning ticket data element; and
mark the winning data element as eligible for another potentially winning data element on another mobile device.

20. The system according to claim 15, wherein the processing device, when executing the non-transitory machine readable instructions, is configured to cause the game administration module to determine whether to award the prize associated with the winning data element portion of the potentially winning ticket by:
determining that the mobile device is online prior to an initiation of the game;
determining that the mobile device is online after the completion of the game; and
determining that a validity period associated with the winning data element portion has not expired.

21. The system according to claim 15, wherein the processing device, when executing the non-transitory machine readable instructions, is configured to cause the game administration module to determine whether the winning data element portion of the potentially winning ticket is winning eligible by:
determining if the prize associated with the winning data element portion of the potentially game winning ticket is available; and
if the mobile device is online, awarding the prize.

22. The system according to claim 21, wherein the processing device, when executing the non-transitory machine readable instructions, is configured to cause the game administration module to, after the prize is awarded, identify a winning data element portion of another potentially winning ticket data element on another mobile device as not winning eligible.
